(19) United States
(12) Patent Application Publication
(10) Pub. No.: US 2011/0122019 A1
(43) Pub. Date: May 26, 2011

(54) APPARATUS FOR SEARCHING A DISTRESS SIGNAL AND THE CONTROLLING METHOD THEREOF

(75) Inventors: Jeom Hun LEE, Daejeon (KR); Sang Uk Lee, Daejeon (KR); Jae Hoon Kim, Daejeon (KR)

(73) Assignee: ELECTRONICS AND TELECOMMUNICATIONS RESEARCH INSTITUTE, Daejeon-city (KR)

(21) Appl. No.: 12/947,884

(22) Filed: Nov. 17, 2010

(30) Foreign Application Priority Data
Nov. 24, 2009 (KR) 10-2009-0114044

(51) Int. Cl. G01S 19/42; G01S 1/00; G01S 19/17

(52) U.S. Cl. 342/357.25; 342/385; 342/357.55

(57) ABSTRACT

Provided are an apparatus for searching a distress signal and a controlling method thereof. The apparatus for searching a distress signal includes: a beacon receiver receiving the distress signal transmitted from a distress beacon apparatus of a COSPAS-SARSAT system; a decoder decoding the distress signal to acquire distress information; and a display unit displaying the acquired distress information. The apparatus for searching a distress signal is used by a search and rescue team.

### CROSS-REFERENCE TO RELATED APPLICATIONS

This application claims priority under 35 U.S.C. §119 to Korean Patent Application No. 10-2009-0114044, filed on Nov. 24, 2009, in the Korean Intellectual Property Office, the disclosure of which is incorporated herein by reference in its entirety.

### TECHNICAL FIELD

The following description relates to a COSPAS-SARSAT system, and more particularly, to an apparatus for searching a distress signal capable of helping a rescue crew to rapidly rescue victims by receiving a distress signal in real time and a controlling method thereof.

### BACKGROUND

Recently, a COSPAS-SARSAT system acquiring distress information of ship, aircraft, etc., from a satellite voyaging above Earth, in which a search and rescue apparatus is mounted, is being used to perform searching and rescuing activities.

In the COSPAS-SARSAT system, ships at sea, mobile terminals on the ground, and aircrafts use distress beacons during distress calls to transmit a 406 MHz emergency beacon signal including locations of distressed terminals, identification numbers of distressed terminals, or the like, every 50 seconds omnidirectionally. Thereafter, the COSPAS-SARSAT satellite receives the transmitted emergency beacon signals and transmits them to a local user terminal (LUT). The LUT extracts distress information from the emergency beacon signal and transmits it to the mission control center (MCC). Next, the mission control center transmits distressed location to a rescue control center (RCC) and the RCC dispatches a search and rescue team to the distressed locations to perform search and rescue.

However, the emergency beacon signal is transmitted to a search and rescue team via the COSPAS-SARSAT satellite, the LUT, the MCC, and the RCC, such that it takes much time for a search and rescue team to receive distress information. In addition, when communication networks have a problem or the distressed location is changed, a search and rescue team cannot directly recognize the location of distressed beacon, such that it is difficult to save a life.

### SUMMARY

In one general aspect, an apparatus for searching a distress signal used by a search and rescue team includes: a beacon receiver receiving the distress signal transmitted from a distress beacon apparatus of a COSPAS-SARSAT system; a decoder decoding the distress signal to acquire distress information; and a display unit displaying the acquired distress information.

In another general aspect, a controlling method of an apparatus for searching a distress signal used by a search and rescue team may include: receiving the distress signal transmitted from a distress beacon apparatus of a COSPAS-SARSAT system; decoding the distress signal to acquire distress information; and displaying the acquired distress information.

Other features and aspects will be apparent from the following detailed description, the drawings, and the claims.

### BRIEF DESCRIPTION OF THE DRAWINGS

FIG. 1 is a configuration diagram showing an exemplary COSPAS-SARSAT system;

FIG. 2 is a configuration diagram showing an exemplary distress signal search apparatus; and

FIG. 3 is a flow chart showing an exemplary controlling method of the distress signal search apparatus.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

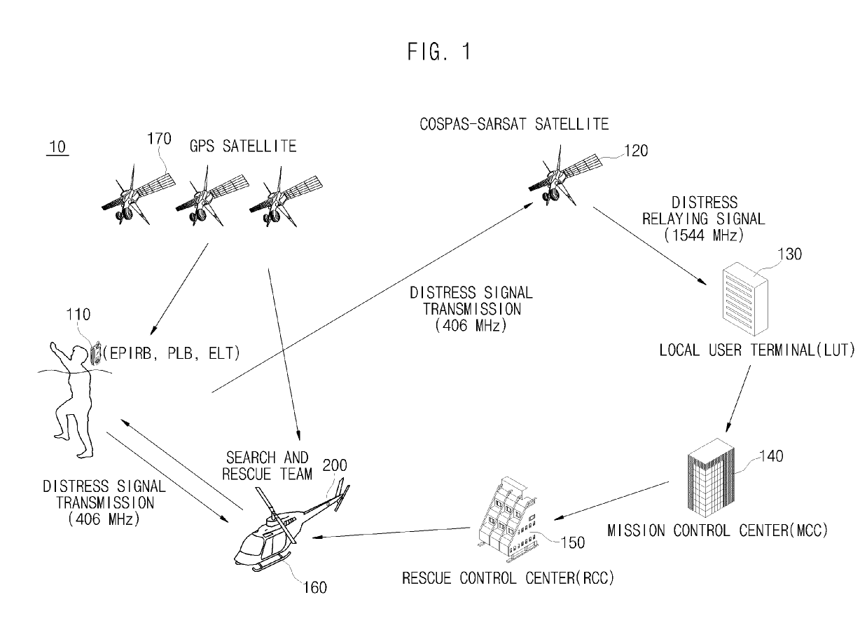

Hereinafter, an exemplary embodiment COSPAS-SARSAT system will be described with reference to FIG. 1. FIG. 1 is a configuration diagram showing an exemplary embodiment COSPAS-SARSAT system.

As shown in FIG. 1, an exemplary COSPAS-SARSAT system 10 includes a distress beacon apparatus 110, a COSPAS-SARSAT satellite 120, a local user terminal 130, a mission control center 140, a rescue control center 150, a search and rescue team 160, and a GPS satellite 170.

The distress beacon apparatus 110 includes at least one of emergency position indicating radio beacons (EPIRB) that are distress beacons for a ship, personal locator beacon (PLB) that is personal portable distress beacon, and an emergency locator transmitter (ELT) that is a distress beacon for an aircraft. And the distress beacon apparatus 110 transmits a distress signal omnidirectionally for continuous predetermined times (for example, 50 seconds) when the distress occurs. In this case, the distress signal is a signal at 406 MHz band including a location of distressed terminal, an identification number of distressed terminal, etc., and is called an emergency beacon signal.

The COSPAS-SARSAT satellite 120 receives the distress signal transmitted from the distress beacon apparatus 110 and transmits a distress relaying signal at 1544 MHz band to the local user terminal (LUT) on the ground.

The local user terminal 130 receives the relaying signal at 1544 MHz band transmitted from the COSPAS-SARSAT satellite 120 and extracts the distress information of the distress beacon apparatus 110 and transmits it to the commission control center 140.

The commission control center 140 determines the distressed location from the distressed information transmitted from the local user terminal 130 and transmits it to the rescue control center 150.

The rescue control center 150 dispatches the search and rescue team 160 to the distressed location transmitted from the commission control center 140.

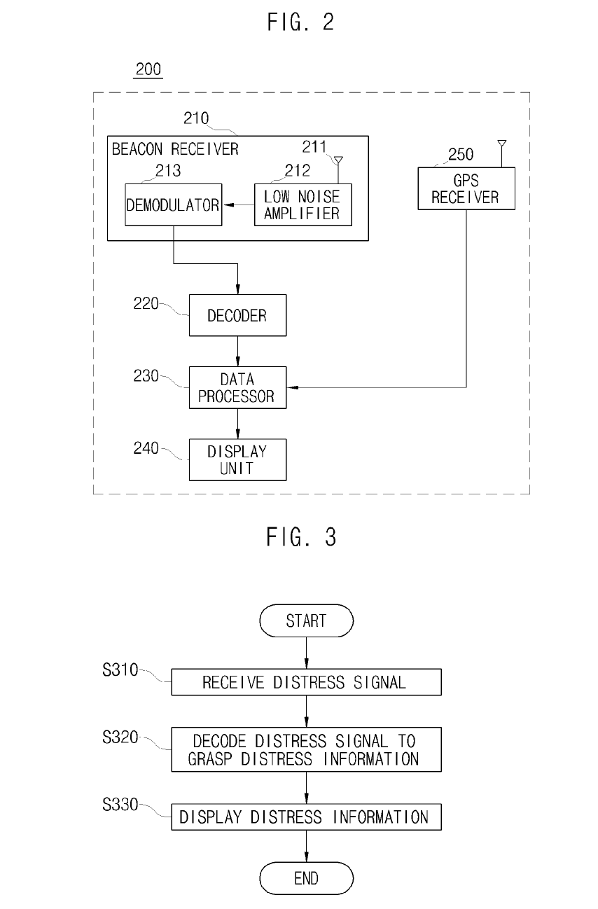

The search and rescue team 160 is dispatched to the distressed location by the rescue control center 150 to perform search and rescue. In this case, the search and rescue team 160 includes a distress signal search apparatus 200 directly receiving the distress signal from the distress beacon apparatus 110 as well as receiving the distress signal via the COSPAS-SARSAT satellite 120, the local user terminal 130, the commission control center 140, and the rescue control center 150 to determine distressed location. In other words, the search and rescue team 160 executes the distress signal search apparatus 200 after it is ordered to mobilize to directly receive the distress signal from the distress beacon apparatus 110, thereby making it possible to rapidly perform distress rescuing activities. Components of the distress signal search apparatus 200 will be described in detail with reference to FIG. 2.

The GPS satellite 170 transmits a GPS signal to allow the search and rescue team 160 and the distress beacon apparatus 110, or the like to determine the present location.

Hereinafter, the exemplary distress signal search apparatus used by the search and rescue team 160 of the COSPAS-SARSAT system 10 will be described with reference to FIG. 2. FIG. 2 is a configuration diagram showing the exemplary distress signal search apparatus.

As shown in FIG. 2, the exemplary distress signal search apparatus 200 includes a beacon receiver 210, a decoder 220, a GPS receiver 250, a data processor 230, and a display unit 240.

The beacon receiver 210 receives the distress signal transmitted from the distress beacon apparatus 110 and includes an antenna 211, a low noise amplifier 212, and a demodulator 213. In this case, the distress signal is a signal in a frequency band defined in the COSPAS-SARSAT, wherein the frequency band may be a frequency at 406 MHz band (for example, 406.025 MHz, 406.028 MHz, 406.031 MHz, 406.034 MHz, 406.037 MHz, 406.040 MHz, or the like) presently defined.

That is, the antenna 211 detects the distress signal transmitted from the distress beacon apparatus 110 and the low noise amplifier 212 performs low noise amplification on the distress signal and the demodulator 213 outputs the distress signal from which carrier is removed by demodulation and provides it to the decoder 220.

The decoder 220 decodes the distress signal and acquires the distress information of the distress beacon apparatus 110. In this case, the distress information includes the location of the distress beacon apparatus 110, the relative direction of the distress beacon apparatus 110 for the present location, the present location, the distance of the distress beacon apparatus 110, or the like, based on the GPS signal.

The GPS receiver 250 receives the GPS signal (or navigation signal) transmitted from the GPS satellite 170 and provides it to a data processor 230.

The data processor 230 determines the present position of the distress signal search apparatus 200 from the GPS signal and associates the present location with the distress information. And the data processor 230 provides it to the display unit 240, such that the display unit 240 can display the distress information associated with the present location.

Hereinafter, an exemplary controlling method of the distress signal search apparatus 200 will be described with reference to FIG. 3. FIG. 3 is a flow chart showing an exemplary controlling method of the distress signal search apparatus.

Referring to FIG. 3, the distress signal search apparatus 200 receives the distress signal transmitted from the distress beacon apparatus 110 of the COSPAS-SARSAT system 10 (S310). In this case, the distress signal is a signal in the frequency band defined in the COSPAS-SARSAT.

Then, the distress signal search apparatus 200 decodes the distress signal and acquires the distress information (S320). In this case, the distress information may be the location of the distress beacon apparatus 110, the relative direction of the distress beacon apparatus 110, the distance of the distress beacon apparatus 110, or the like.

Next, the distress signal search apparatus 200 displays the acquired distress information on the display (S330). In this case, the distress signal search apparatus 200 receives the GPS signal from the GPS satellite to determine the present location and associates the present position with the distress information to display.

In detail, the distress signal search apparatus 200 may display an accurate location of the distress beacon apparatus 110, the direction of the distress beacon apparatus 110 for the present location, and a spaced distance between the present location and the distress beacon apparatus 110 (by magnifying a map), or the like, based on the GPS signal.

According to the exemplary embodiments, the search and rescue team can recognize the changed distress information or the distress signal changed after it is ordered to mobilize in real time. Accordingly, it can be better when an emergency rescue should rapidly be performed for example vessel sank especially in the winter or location of victims is changed due to geographic location such as a mountain or a valley, etc.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for searching a distress signal used by a search and rescue team, comprising:
a beacon receiver receiving the distress signal transmitted from a distress beacon apparatus of a COSPAS-SARSAT system;
a decoder decoding the distress signal to acquire distress information; and
a display unit displaying the acquired distress information.

2. The apparatus of claim 1, wherein the distress beacon apparatus includes at least one of a distress beacon for a ship, a personal portable distress beacon, and a distress beacon for an aircraft.

3. The apparatus of claim 1, wherein the distress information includes at least one of a location of the distress beacon apparatus, a relative direction of the distress beacon apparatus, and a distance from the distress beacon apparatus.

4. The apparatus of claim 1, wherein the distress signal is a signal in a frequency band defined in a COSPAS-SARSAT.

5. The apparatus of claim 1, further comprising a GPS receiver receiving a GPS signal transmitted from a GPS satellite.

6. The apparatus of claim 5, further comprising a data processor associating the present position determined from the GPS signal with the distress information and providing the associated distress information to the display unit.

7. A controlling method of an apparatus for searching a distress signal used by a search and rescue team, comprising:
receiving the distress signal transmitted from a distress beacon apparatus of a COSPAS-SARSAT system;
decoding the distress signal to acquire distress information; and
displaying the acquired distress information.

8. The method of claim 7, further comprising:
receiving a GPS signal from a GPS satellite;
determining a present location using the GPS signal; and
associating the present location with the distress information,
wherein the displaying displays the associated distress information.

9. The method of claim 7, wherein the distress information includes at least one of a location of the distress beacon apparatus, a relative direction of the distress beacon apparatus, and a distance from the distress beacon apparatus.

10. The method of claim 7, wherein the distress signal is a signal in a frequency band defined in a COSPAS-SARSAT.
